(19) United States
(12) Patent Application Publication
(10) Pub. No.: US 2011/0265676 A1
(43) Pub. Date: Nov. 3, 2011

(54) METHOD AND SYSTEM FOR ADJUSTING AND CONTROLLING A PRINTING MACHINE BY EMPLOYING MINUTE MARKS

(75) Inventors: Shahar Golan, Petah Tikva (IL); Dan Zamir, Hod Hasharon (IL); Alexander Cherneco, Natania (IL); Maytal Schwartzman, Kfar Saba (IL)

(73) Assignee: Advanced Vision Technology (AVT)Ltd., Neve Ne'eman (IL)

(21) Appl. No.: 13/100,045

(22) Filed: May 3, 2011

Related U.S. Application Data
(60) Provisional application No. 61/330,715, filed on May 3, 2010.

(51) Int. Cl. B41F 1/34

(52) U.S. Cl. 101/485

(57) ABSTRACT

A method for registering a press machine including printing stations, each including a plate roller with a printing plate. Each printing plate includes a microdot engraving. The method includes displacing the plate rollers with respect to each other for scattering them, printing a scattered microdot pattern on a print substrate, acquiring an image of the scattered microdot pattern, associating the plate rollers with their respective microdot marks, and displacing the plate rollers to a registered position, Each of the plate rollers is associated with a unique scattered displacement and with its respective microdot mark according to the position of its respective microdot mark relative to the other microdot marks in the scattered microdot pattern, and to the unique scattered displacement of the plate roller. The plate rollers are displaced to a registered position according to the position of their respective microdot marks relative to the other microdot marks.

This application claims benefit of U.S. Ser. No. 61/330,715, filed 3 May 2010 and which application is incorporated herein by reference. To the extent appropriate, a claim of priority is made to the above disclosed application.

### FIELD OF THE DISCLOSED TECHNIQUE

The disclosed technique relates to setting up and controlling press machines, in general, and to methods and systems for setting up and controlling register between colors on printing machines by employing minute marks that are inherent to the printing process, without requiring the addition of special targets, in particular.

### BACKGROUND OF THE DISCLOSED TECHNIQUE

A color image is printed on a web substrate (e.g., paper) by employing various methods, such as the flexographic printing method and the rotogravure printing method. The flexographic printing method is performed by employing a plurality of printing stations of a press machine. Each printing station is related to a different ink (e.g., different color). Each printing station includes a plate roller, a printing plate, an anilox roller and an impression cylinder. The plate roller is located between the anilox roller and the impression cylinder. The printing plate is mounted around at least a portion of the plate roller.

The plate roller (i.e., and the printing plate mounted there-around) is in contact with the anilox roller and with the impression cylinder. The web substrate is wound around the impression cylinder. The printing plate includes a pattern of an image which is to be printed on the web substrate (i.e., an image engraving). The anilox roller picks up ink from an ink basin and transfers the ink to the printing plate. The printing plate prints an image on the web substrate, according to the image pattern thereof.

The color of a color image for printing may be a basic color in a color gamut (e.g., CYMK), or a pantone color. For printing the color image on the web substrate, a printing press includes a flexographic printing station respective of each of the basic color separations plus an additional flexographic printing station for each pantone color, located in sequence. For example, one flexographic printing station for producing the image in Cyan, one for Magenta, one for Yellow, one for Black, and one for a pantone color. Each flexographic printing station includes a plate roller, a printing plate, an anilox roller and an ink basin.

The outer surface of each of the rollers (i.e., the anilox roller, the printing plate and the press roller) is made of a resilient material, such as rubber, so that the pressure there between can be adjusted, by varying the distance between the rollers. Prior to the print run, the printing press has to be set up (i.e., adjusted) in order to print the image on the web substrate, at an acceptable quality level. Additionally, for the pattern to be printed properly, the printing stations in the printing press must be registered with each other (i.e., each station prints the respective pattern thereof at the respective relative location associated therewith).

U.S. Pat. No. 6,591,746 issued to Siler, and entitled “Registration System for Printing Press”, is directed at a method for registering printing rollers of a printing press. The method includes the procedures of printing a first pair of registration marks in a first color, printing a second pair of registration marks in a second color, printing a third pair of registration marks with a third color, generating image data representing the printed registration marks and identifying the pairs of registration marks. The first pair, the second pair and the third pair, of registration marks, are printed on a web material by a first printing roller, a second printing roller and a third printing roller, respectively. The pairs of registration marks are identified according to the image data and to registration mark reference data. The identified registration marks are employed for registering the respective print rollers.

### SUMMARY OF THE PRESENT DISCLOSED TECHNIQUE

It is an object of the disclosed technique to provide a novel method and system for adjusting a press machine (e.g., registering plate rollers, adjusting pressure, adjusting color) by detecting minute marks at a first low zoom level image, and measuring characteristics (e.g., position, dimensions, color) of the minute marks at a second higher zoom level for adjusting the press machine.

In accordance with the disclosed technique, there is thus provided a method for registering a press machine. The press machine includes a plurality of printing stations. Each one of the printing stations includes a plate roller mounted with a printing plate. Each one of the printing plates includes a microdot engraving. The method includes the following steps, displacing the plate rollers for scattering the respective microdot marks, printing on a print substrate a microdot marks scattered pattern, acquiring an image of the scattered pattern, associating the plate rollers with their respective microdot marks, and displacing the plate rollers to registered configuration.

Each one of the plate rollers is associated with a unique scattered displacement, with respect to each of the other plate rollers. Each one of the plate rollers (i.e., microdot engraving) prints a respective microdot mark on the print substrate, thereby producing together a scattered microdot pattern. Each one of the plate rollers is associated with its respective microdot mark according to the position of its respective microdot mark relative to the other microdot marks in the scattered microdot pattern, and further according to the unique scattered displacement of the plate roller. The plate rollers are displaced to a registered configuration according to the position of their respective microdot marks relative to the other microdot marks.

### BRIEF DESCRIPTION OF THE DRAWINGS

The disclosed technique will be understood and appreciated more fully from the following detailed description taken in conjunction with the drawings in which:

FIG. 1 is a schematic illustration of a press machine, constructed and operative in accordance with an embodiment of the disclosed technique;

FIG. 2 is a schematic illustration of a printing station, constructed and operative in accordance with another embodiment of the disclosed technique;

FIGS. 3A, 3B, 3C and 3D, are schematic illustrations of a plate roller assembly, constructed and operative in accordance with a further embodiment of the disclosed technique;

FIGS. 4A, 4B, 4C, 4D, 4E, 4F, 4G and 4H, are schematic illustrations of a double file pattern of microdot marks, constructed and operative in accordance with another embodiment of the disclosed technique;

FIGS. 5A, 5B, 5C, 5D and 5E, are schematic illustrations of a single file pattern of microdot marks, constructed and operative in accordance with a further embodiment of the disclosed technique; and

FIGS. 6A and 6B, are schematic illustrations of a method for registering and setting up a press machine, operative in accordance with another embodiment of the disclosed technique.

### DETAILED DESCRIPTION OF THE EMBODIMENTS

The disclosed technique overcomes the disadvantages of the prior art by providing a method and a system for registering a plurality of printing plates of a press machine, based on the use of minute dots (i.e., microdots). The minute dots are printed as an inherent part of the printing process, and thus do not require adding designated targets on the printing plate (i.e., either new or existing printing plates). Thus, the space of such targets on the printing plate is saved. The method includes the procedures detailed herein below. The method assumes that the printing plates of the press machine are conventionally initially registered by employing the microdot engravings. The microdots are part of the printing pattern and therefore leave marks on the print substrate. A scattering control signal is determined for uniquely displacing each of the printing rollers of the press machine. Each of the plate rollers is uniquely displaced according to the scattering control signal. The image, including the microdot marks of each of the printing plates is printed on the printed material, producing a scattered microdot pattern on the printed material. Each microdot mark of the microdot pattern is uniquely associated with its respective plate roller. The location of the scattered microdot pattern on the printed image on the printed material is determined. An image of the scattered microdot pattern is acquired. The relative position of each microdot mark with respect to a reference point is determined according to the image of the microdot pattern. The plate rollers of the press machine are displaced according to the determined relative positions of the respective microdot marks and thereby the plate rollers of the press machine are registered.

It is noted that, the location of the scattered microdot pattern on the print substrate is identified by scanning the print substrate with a camera having a low zoom level and corresponding wide Field of View (FOV). At this level of zoom, the microdot pattern is discernible, but the size (i.e., the number of pixels) of each individual microdot in the image is too small to be usefully analyzed. Once the scattered microdot pattern is located, it is imaged with a camera having a narrow field of view, or with the same camera having a plurality of zoom levels and corresponding FOVs. In this manner, every microdot mark of the microdot pattern occupies several pixels of the image and is clearly visible, such that it can be analyzed, for example, by employing an image processing software (i.e., at the higher zoom level and smaller FOV).

The method of scanning for the microdot pattern at a first zoom level and than imaging the pattern at a higher zoom level for better analysis of the microdot pattern can further be employed for adjusting the press machine and the color of the printed image. The microdot marks are printed during any printing process. The microdot marks are typically too small when imaged with the lower zoom level to be usefully processed. The microdot pattern is identified at one level of zoom (i.e., low level) and then processed at another level (i.e., high level) of zoom, in order to provide useful feedback to a print operator or to the printing machine itself. The microdot pattern can be employed for alerting the operator (i.e., indicating to the operator) of the press machine to the actuation of various actuators of the press machine in accordance with a respective actuation signal.

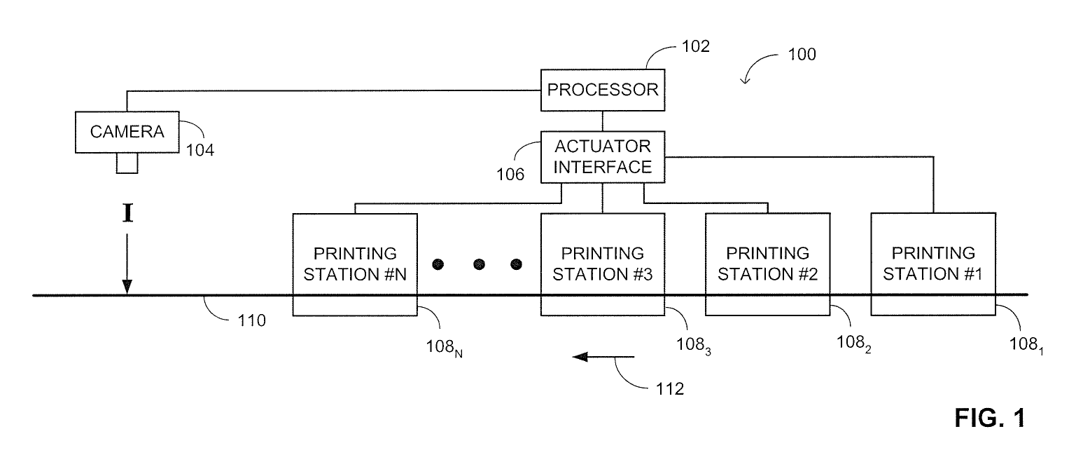

For example, a control signal (i.e., actuation signal) for displacing the plate rollers for setting up the pressure of the plate rollers is started with an instruction for displacing a single plate roller such that its corresponding microdot mark will move back and forth. When the operator or image processing software identifies the back and forth movement of the respective microdot mark, the operator or image processing software knows the setting up procedure started at that exact position on the printed material. It is noted, that in the description herein below, every operation of the operator can be performed also by a controller (e.g., processor 102 of FIG. 1) and appropriate software (e.g., image processing software). It is further noted that the operator and the controller are interchangeable throughout the description and each controlling operation can be performed either by an operator or by a controller.

Reference is now made to FIG. 1, which is a schematic illustration of a press machine, generally referenced 100, constructed and operative in accordance with an embodiment of the disclosed technique. Press machine 100 includes a processor 102, a camera 104, an actuator interface 106, a plurality of printing stations 108₁, 108₂, 108₃, . . . , 108_{N}, and a print substrate 110. Processor 102 is coupled with camera 104 and with actuator interface 106. Actuator interface 106 is coupled with respective actuators (not shown) of rollers (not shown) of plurality of printing stations 108₁, 108₂, 108₃, . . . , 108_{N}.

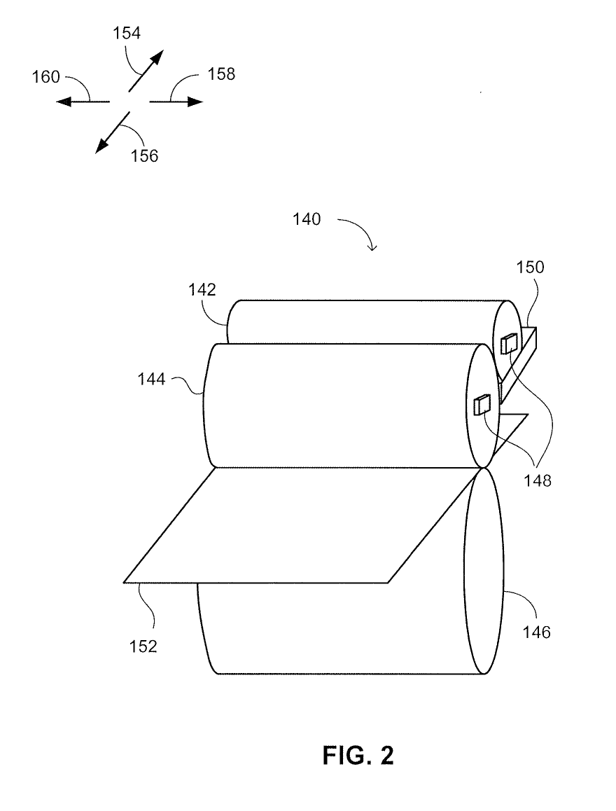

The structure of each of printing stations 108₁, 108₂, 108₃, . . . , 108_{N}, is further detailed herein below with reference to FIG. 2. Each of printing stations 108₁, 108₂, 108₃, . . . , 108_{N} can be of a different type, for example, flexographic, gravure, offset, and the like. A print substrate 110 passes through a plurality of rollers of each of printing stations 108₁, 108₂, 108₃, . . . , 108_{N}, in sequence, in a direction designated by an arrow 112. As detailed herein above in the background section, each of printing stations 108₁, 108₂, 108₃, . . . , 108_{N} is associated with a different color.

Camera 104 observes print substrate 110. Camera 104 is a device which can detect the presence or absence of a pattern, which is printed by printing stations 108₁, 108₂, 108₃, . . . , 108_{N} of printing press 100 on a print substrate (e.g., paper web, PET, cardboard). Camera 104 can detect the presence of patterns having different characteristics (e.g., color, shape, location). Accordingly, camera 104 can be a black and white gray level camera or a color camera. Camera 104 can be in the form of a linear charge-coupled device (CCD), CCD array, and the like. The CCD can be made of a semiconductor, such as silicon, complementary metal-oxide semiconductor (CMOS), and the like.

In one embodiment, camera 104 is an area camera, which images an area. The pixel resolution of camera 104 is, for example, 1024×768 pixels. Camera 104 is a zoom camera which enables zooming in onto smaller image areas, thereby decreasing its Field of View (FOV), and vice versa. Camera 104 can move along the width of the print substrate 110, such that camera 104 can image any portion of print substrate 110 at any of its respective zoom levels. Press machine 100 can include one or more cameras (not shown) in addition to camera 104. Alternatively, camera 104 is a line camera with zoom lens.

Actuator interface 106 is coupled with a set of actuators (not shown) of each of printing stations 108₁, 108₂, 108₃, . . . , 108_{N}. Actuator interface 106 can be in the form of a digital to analog converter (ADC), which converts a digital output of processor 102 to an analog output, in order to actuate the actuators of each of printing stations 108₁, 108₂, 108₃, . . . , 108_{N}. The actuators can be a rotary electric motor, a linear electric motor, piezoelectric actuator, hydraulic actuator, pneumatic actuator, bimetallic actuator, and the like. The actuators can include a power transmission (not shown), such as gears, pulleys, timing belts, and the like.

Reference is now made to FIG. 2, which is a schematic illustration of a printing station, generally referenced 140, constructed and operative in accordance with another embodiment of the disclosed technique. Printing station 140 is substantially similar to each of printing stations 108₁, 108₂, 108₃, . . . , 108_{N} of FIG. 1. Printing station 140 includes an anilox roller 142, a plate roller 144, an impression cylinder 146, actuators 148 and an ink basin 150.

Anilox roller 142 is in rolling contact with plate roller 144. Plate roller 144 is in rolling contact with an impression cylinder 146. A print substrate 152 is located between plate roller 112 and impression cylinder 146. Actuators 148 are coupled with each of anilox roller 142 and plate roller 144. It is noted that each of anilox roller and plate roller 144 can be actuated and controlled separately. Anilox roller is in rolling contact with ink basin 150.

Print substrate 152 can be in the form of a web (e.g., paper) which unwinds from impression cylinder 146 to be rolled around a take-up cylinder (not shown). Each of anilox roller 142 and impression cylinder 146 is made of a rigid material, such as metal, ceramic, and the like. An outer surface of the printing plate of plate roller 144 is made of an elastic material, such as photopolymer, an elastomeric polymer (e.g., natural rubber, synthetic rubber), and the like.

Actuators 148 move each of plate roller 144 and anilox roller 142 in each one of the directions designated by arrows 154, 156, 158 and 160. Moving the printed image in the direction of arrows 154 and 156 may be accomplished by changing the angular phase of rotation of plate roller 144 (e.g., by temporarily increasing or decreasing the angular velocity of plate roller 144).

Anilox roller 142 rolls through ink basin 150 and picks up ink therefrom. A printing plate (not shown) is coupled around plate roller 144. The printing plate includes an engraving of an image to be printed thereon. The printing plate is in rolling contact with anilox roller 142, such that anilox roller 142 transfers ink to the engraving of the image to be printed of the printing plate. The printing plate periodically prints (i.e., with each rotation of plate roller 144) an image on print substrate 152 which corresponds to the engraving of the printing plate.

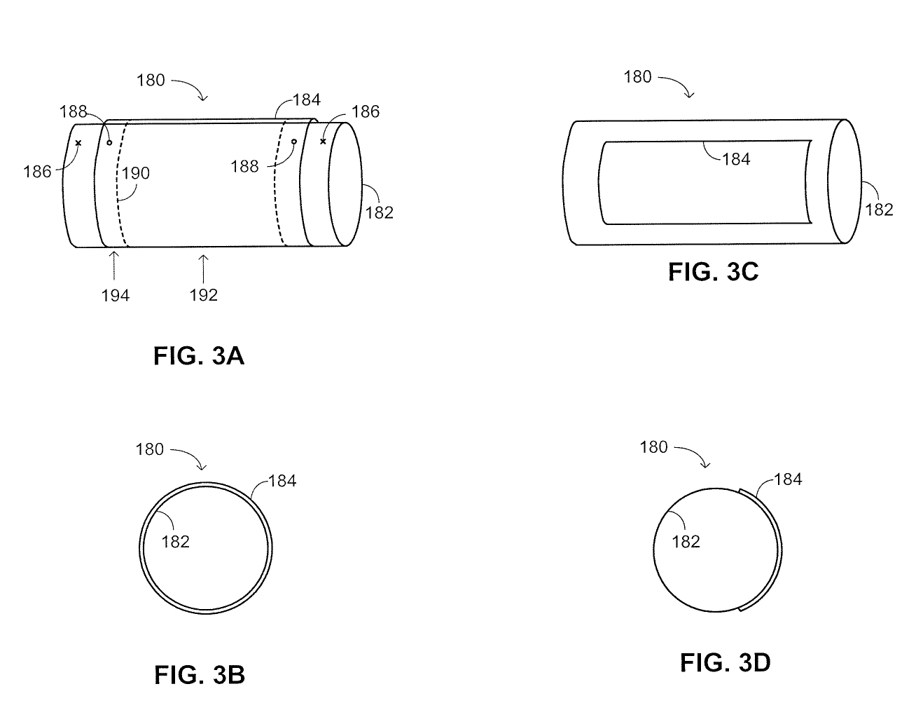

Reference is now made to FIGS. 3A, 3B, 3C and 3D, which are schematic illustrations of a plate roller assembly, generally referenced 180, constructed and operative in accordance with a further embodiment of the disclosed technique. FIG. 3A shows plate roller assembly 180 from a front view. FIG. 3B shows plate roller assembly 180 from a side view. Plate roller assembly 180 includes a plate roller 182 and a printing plate 184. Printing plate 184 is mounted around plate roll 182. In the example set forth in FIGS. 3A and 3B, printing plate is in the shape of a closed cylinder, completely surrounding plate roller 182. Alternatively, the printing plate is in the shape of a portion of a cylinder, and is only surrounding a portion of the plate roller, as depicted in FIGS. 3C and 3D.

Plate roller 182 includes a couple of registration marks 186. Registration marks 186 are detectable by a camera (e.g., camera 104 of FIG. 1). Printing plate 184 is mounted around plate roller 182, such that registration marks 186 of plate roller 182 are uncovered by printing plate 182. Printing plate 184 includes a couple of microdot engravings 188, an image engraving portion 192, and a couple of margins portions 194 on either side of image engraving portion 192. In the example set forth in FIG. 3A, image engraving portion 192 is separated from margins portions 194 by an imaginary border line 190.

Image engraving portion 192 includes an engraving of an image (not shown) to be printed on a print substrate (not shown—e.g., print substrate 110 of FIG. 1) by printing plate 184. Microdot engravings 188 produce microdot marks (not shown) on the print substrate. The printed microdot marks are detectable by the camera. For the purpose of registration, each of microdot engravings 188 is intentionally surrounded by a clean area, which is not printed on (i.e., the clean area is not covered with ink). For example, margins portions 194 are empty of image engravings and are considered as a clean area around microdot engravings 188. The clean area maintains the microdot marks uncovered by ink and thus, clearly visible. Naturally, it is desired that the clean area will be minimal so as not to waste print substrate. Therefore, microdot engravings 188 are usually positioned on one of the side-margins of the printing plate.

The dimensions (i.e., the diameter) of each microdot engraving 188, and therefore of each microdot mark, are approximately 0.2 millimeters. Alternatively, the dimensions and shape of the microdots can vary and the microdots can be of different shapes and sizes. In the example set forth in FIG. 3A there are two registration marks 186 and two microdot engravings 188. Alternatively, there could be any other number of registration marks and microdot engravings, such as one registration mark and one microdot engraving, position on a selected side of the printing plate. It is noted that, the number of registration marks can vary from the number of microdot engravings.

Registration marks 186 and the microdot marks, printed by microdot engravings 188, are employed for initial registration of a plurality of printing plates of a press machine (e.g., press machine 100 of FIG. 1). Each printing plate is mounted onto its respective plate roller in a position and angular phase, such that the microdot engravings correspond to the registration marks of the plate roller.

For example, registration marks 186 can be mounting pins coupled with plate roller 182 and employed for mounting plate roller 182 onto the press machine. The mounting pins latch into holes on the press. A camera (e.g., camera 104 of FIG. 1) images microdot engravings 188 and the mounting pins (i.e., registration marks 186). The images of microdot engravings 188 and of the mounting pins are employed for positioning printing plate 184, in a repeatable fashion relative to the mounting pin, onto roller plate 182.

The microdot marks produce a pattern (i.e., a microdot pattern) on the print substrate. When in perfect registration, the microdots overlap and therefore cover each other. Prior to full registration, the microdots are spread out in a random pattern over some area. The maximal radius of the microdot pattern is defined as the Initial Mis-Register (IMR) of the press machine. In particular, the maximal radius of the microdot pattern of a press machine equals the IMR of the press machine. For example, a press machine having an IMR of three millimeters has a microdot pattern, which maximal radius thereof is three millimeters. Employing the microdot marks and the registration marks for registering the printing plates of a press machine enables reusing existing plate rollers which are not specifically adapted for other methods of registration and which include registration marks and microdot engravings.

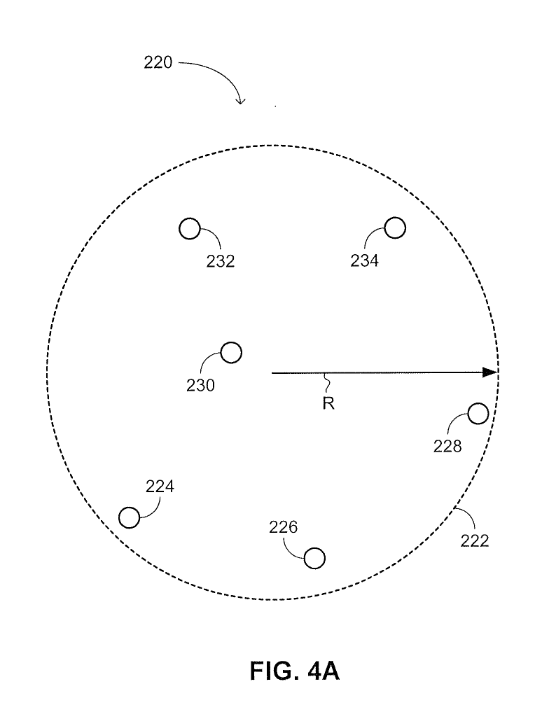

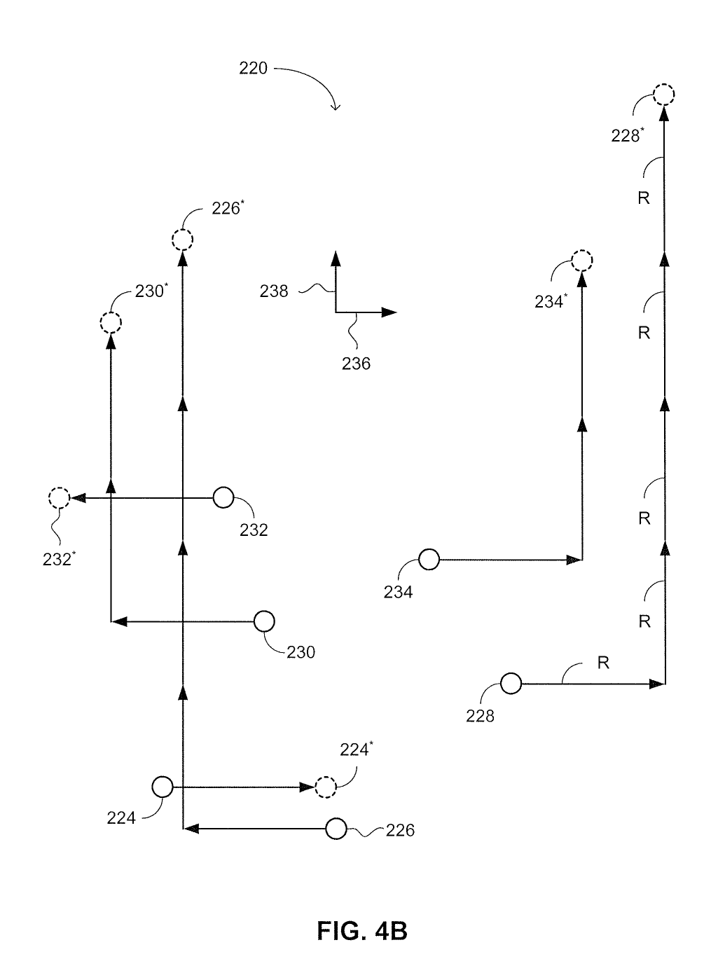

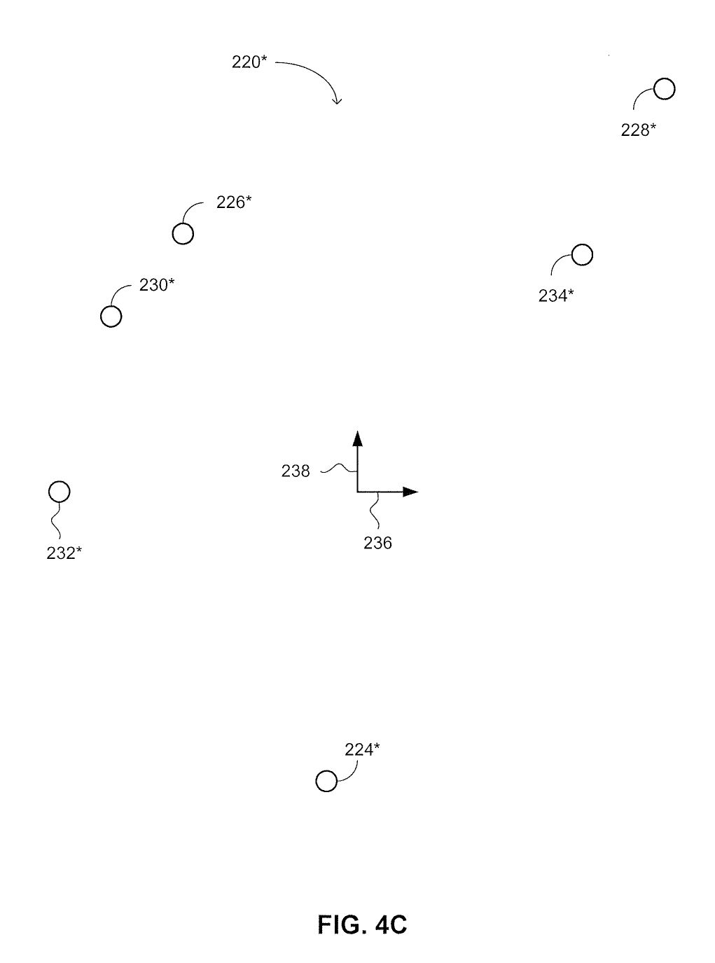

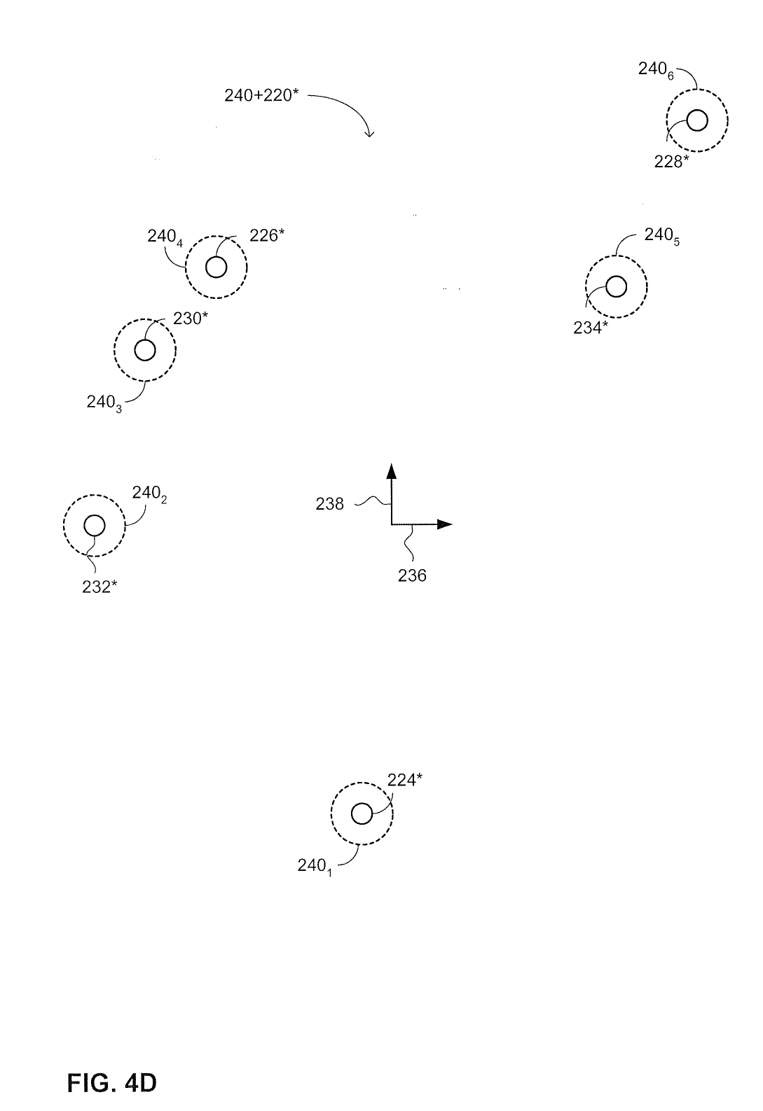

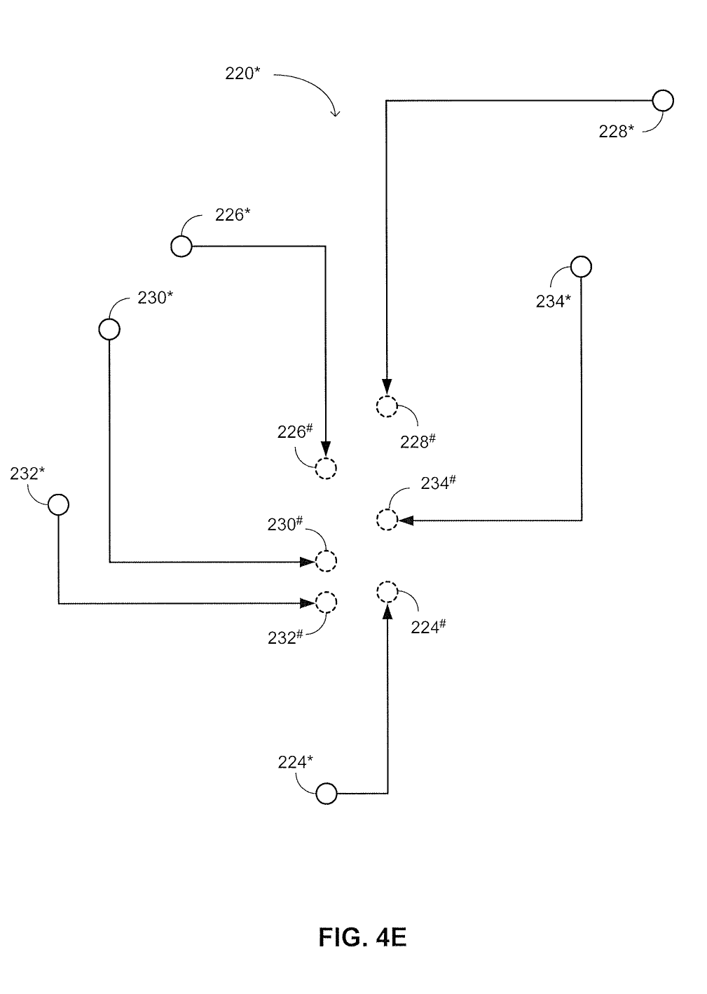

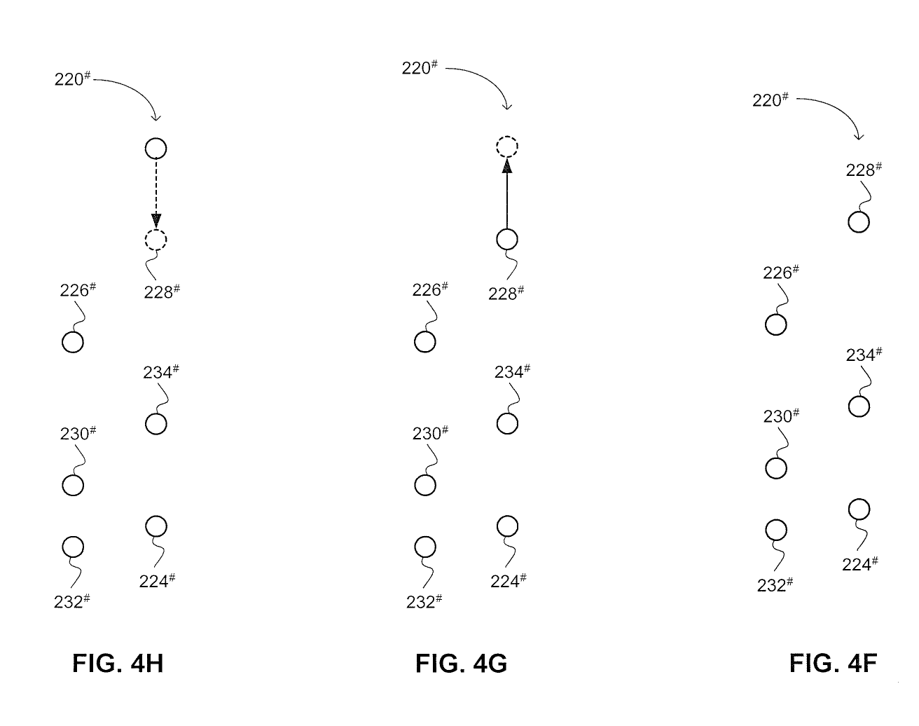

Reference is now made to FIGS. 4A, 4B, 4C, 4D, 4E, 4F, 4G and 4H, which are schematic illustrations of a double file pattern of microdot marks (i.e., double file microdot pattern), generally referenced 220, constructed and operative in accordance with another embodiment of the disclosed technique. With reference to FIG. 4A, microdot pattern 220 includes a first microdot mark 224, a second microdot mark 226, a third microdot mark 228, a fourth microdot mark 230, a fifth microdot mark 232 and a sixth microdot mark 234. Each of microdot marks 224, 226, 228, 230, 232 and 234 is produced by a microdot engraving of a respective printing plate (e.g., printing plate 184 of FIG. 3) of a press machine (e.g., press machine 100 of FIG. 1). For the sake of brevity, in the example set forth in FIGS. 4A-4H, only the microdot marks of a selected side of the printing plates are presented.

Microdot pattern 220 is bounded by an imaginary circle 222. Imaginary circle 222 has a radius R which corresponds to the IMR of the press machine. The position of each microdot mark within microdot pattern 220 corresponds to the position of the respective microdot engraving and therefore to the position of the respective printing plate. It is noted that, it might be impossible to uniquely associate each of microdot marks 224, 226, 228, 230, 232 and 234 with each plate roller according to initial microdot pattern 220.

With reference to FIG. 4B, a processor (e.g., processor 102 of FIG. 1) determines a scattering control signal for an actuation interface (e.g., actuation interface 106 of FIG. 1). In particular, the processor determines a unique scattering control signal for uniquely displacing each of the plate rollers of the press machine. It is noted that the unique scattering control signal for a selected plate roller can be zero displacement, such that plate roller does not move.

The scattering control signal is directed at scattering microdot pattern 220 and producing a scattered microdot pattern (e.g., scattered microdot pattern 220* of FIG. 4C). Scattered microdot pattern 220* and the scattering control signal enable unique association of each of microdot marks 224, 226, 228, 230, 232 and 234, with its respective printing plate (i.e., and its respective plate roller and printing station). Each plate roller is moved to a unique position which is clearly distinguishable from the positions of the other plate rollers. For example, if a first plate roller is moved by a distance of more than two IMR, the microdot mark corresponding to the first roller plate would be distinctly separate from the rest of the microdot marks. It is noted that the scattering control signal can combine roller plate displacement in more than a single axis. For example, the plate rollers are displaced in two perpendicular axes.

FIG. 4B shows microdot marks 224, 226, 228, 230, 232 and 234 before and after the scattering displacement respective of the scattering control signal, depicted as full line circles and as dotted line circles, respectively. The scattered microdot marks are denoted by an asterisk. For example, microdot mark 224 after being displaced in accordance with the scattering control signal, is denoted as microdot 224*.

Specifically, microdot mark 224 is moved in the direction of arrow 236 by a distance of R (i.e., as detailed herein above R equals the IMR of the press machine). Microdot 226 is moved in the direction opposite that of arrow 236 by a magnitude of R, and is further moved in the direction of arrow 238 by a magnitude of 4R. Microdot 228 is moved in the direction of arrow 236 by a magnitude of R, and is further moved in the direction of arrow 238 by a magnitude of 4R. Microdot 230 is moved in the direction opposite that of arrow 236 by a magnitude of R, and is further moved in the direction of arrow 238 by a magnitude of 2R. Microdot 232 is moved in the direction opposite that of arrow 236 by a magnitude of R. Microdot 234 is moved in the direction of arrow 236 by a magnitude of R, and is further moved in the direction of arrow 238 by a magnitude of 2R. Each plate roller receives a unique control signal, respective of a unique displacement.

It is noted that arrow 236 is substantially parallel to the width dimension of the print substrate (e.g., print substrate 110 of FIG. 1). It is further noted that, in the example set forth in FIG. 4B, half the microdot marks (i.e., microdot marks 226, 230 and 232) are scattered in a first direction and the other half (i.e., microdot marks 224, 228 and 234) are scattered in the opposite direction. Thereby, microdot pattern 220 is effectively separated into two columns (i.e., double file scattered microdot pattern 220*).

With reference to FIG. 4C, scattered microdot pattern 220* enables associating each of scattered microdot marks 224*, 226*, 228*, 230*, 232* and 234* with its respective plate roller. The association of the microdot marks and their respective plate rollers can be performed in a plurality of methods.

A first method involves mapping each of microdot scattered marks 224*, 226*, 228*, 230*, 232* and 234* to a respective microdot mark 224, 226, 228, 230, 232 and 234 of microdot initial pattern 220, in accordance with the scattering control signal. For example, by applying a reverse displacement of each of the unique displacements of the scattering control signal, on each of scattered microdot marks 224*, 226*, 228*, 230*, 232* and 234*, it is possible to determine which scattered microdot mark corresponds to which microdot mark of initial microdot pattern 220 and to which plate roller. Scattered microdot mark 224* is being displaced in accordance with a reverse of a first scattering control signal and thereafter coincides with microdot mark 224. Therefore, microdot mark 224 and scattered microdot mark 224* correspond to the first plate roller associated with the first control signal.

The second method involves analyzing scattered microdot pattern 220* and determine which of scattered microdot marks 224*, 226*, 228*, 230*, 232* and 234*, corresponds to which one of the roller plates, according to the scattering control signal. In particular, in the example set forth in FIG. 4C, the left uppermost scattered microdot mark 226* corresponds to the roller plate which received the unique scattering control signal of moving in the direction opposite of arrow 236 by a distance of R and further moving in the direction of arrow 238 by a distance of 4R. The right uppermost scattered microdot mark 228* corresponds to the roller plate which received the unique scattering control signal of moving in the direction of arrow 236 by a distance of R and further moving in the direction of arrow 238 by a distance of 4R. The left middle scattered microdot mark 230* corresponds to the roller plate which received the unique scattering control signal of moving in the direction opposite of arrow 236 by a distance of R and further moving in the direction of arrow 238 by a distance of 2R. The right middle scattered microdot mark 234* corresponds to the roller plate which received the unique scattering control signal of moving in the direction of arrow 236 by a distance of R and further moving in the direction of arrow 238 by a distance of 2R. The left bottom scattered microdot mark 232* corresponds to the roller plate which received the unique scattering control signal of moving in the direction opposite of arrow 236 by a distance of R. The right bottom scattered microdot mark 224* corresponds to the roller plate which received the unique scattering control signal of moving in the direction of arrow 236 by a distance of R.

Alternatively, the processor produces a different scattering control signal for each of the plate rollers for producing a different scattered microdot pattern which enables unique association of each microdot mark with its respective plate roller in any of the above detailed methods or in any alternative method which involves analysis of initial microdot pattern 220, scattered microdot pattern 220* and the scattering control signal. It is noted that any scattering control signal which scatters the microdot marks such that the distance between each pair of marks exceeds 2R would enable unique association of the microdot marks with their respective plate rollers. This is due to the maximal distance between two microdot marks in the initial microdot pattern 220 (FIG. 4A), which is 2R.

The unique association of each microdot mark with its respective plate roller enables registration of the printing plates of the press machine by measuring the distances between microdot marks and displacing the marks accordingly for overlapping the marks on each other. The accuracy of the registration of the printing plates depends on the accuracy of the measurement of the distances between the microdots, or on the measurement of the relative position of each microdot mark with respect to a common reference point (not shown). The accuracy of the measurements can be improved by concentrating the microdot marks and producing a concentrated microdot pattern (not shown).

The concentrated microdot pattern increases the accuracy of the distance measurements since the error in the measurements depends on the measured number of pixels between the microdot marks in the image (i.e., the larger the number of pixels between microdot marks in the image, the more accurate the distance measurement). Since a concentrated pattern can be imaged at a higher zoom level, this increases the number of image pixels between the imaged microdot marks, thus enabling more accurate measurements. For example, in case the length of the scattered microdot pattern is 10 centimeters, and the error of measurement is 1%, the error will be 0.1 centimeters. In case the length of the scattered microdot pattern is 5 centimeters, the error will be 0.05 centimeters. Another example, in case the length of the scattered microdot pattern is 10 centimeters, the pattern can be viewed in a single frame at a first zoom level having a measurement error of 0.1 millimeters. In case the length of the scattered microdot pattern is 5 centimeters, the pattern can be viewed in a single frame at a second zoom level (i.e., higher than the first zoom level) having a measurement error of 0.01 millimeters. It is noted that the required registration accuracy is at least 50 micrometers (i.e., microns).

With reference to FIG. 4D, an operator (now shown) can identify and mark microdot scattered pattern 220* by employing scattered pattern cursor 240. Scattered pattern cursor 240 includes a plurality of microdot cursor areas 240₁, 240₂, 240₃, 240₄, 240₅, and 240₆. Each of microdot cursor areas 240₁, 240₂, 240₃, 240₄, 240₅, and 240₆, corresponds to a respective microdot marks. The number of microdot cursor areas corresponds to the number of microdot marks and the relative position of each microdot cursor area corresponds to the relative position of each microdot mark. Each of microdot cursor areas 240₁, 240₂, 240₃, 240₄, 240₅, and 240₆ is of a size sufficient to make sure that its respective microdot mark fits therein, while all other microdot cursor areas contain their respective microdot marks. For example, the radius (not shown) of each of microdot cursor areas 240₁, 240₂, 240₃, 240₄, 240₅, and 240₆ is twice the IMR of the press machine.

In particular, microdot cursor areas 240₁ corresponds to microdot mark 224*. Microdot cursor areas 240₂ corresponds to microdot mark 232*. Microdot cursor areas 240₃ corresponds to microdot mark 230*. Microdot cursor areas 240₄ corresponds to microdot mark 226*. Microdot cursor areas 240₅ corresponds to microdot mark 234*. Microdot cursor areas 240₆ corresponds to microdot mark 228*. Scattered pattern cursor 240 is generated by a controller (e.g., processor 102 of FIG. 1). The operator maneuvers scattered pattern cursor 240 to overlap scattered microdot pattern 220*, such that each microdot mark fits within its respective microdot cursor area. Thereby, the operator signals the controller the exact location of scattered microdot pattern within an image thereof.

With reference to FIG. 4E, the processor produces a concentrating control signal for the actuation interface. The concentrating control signal is directed at displacing the plate rollers for concentrating scattered microdot marks 224*, 226*, 228*, 230*, 232* and 234*, thereby producing a concentrated microdot pattern 220^{#} (FIG. 4F). FIG. 4E shows scattered microdot marks 224*, 226*, 228*, 230*, 232* and 234*, depicted as full circles, and concentrated microdot marks 224^{#}, 226^{#}, 228^{#}, 230^{#}, 232^{#} and 234^{#}, depicted as dotted circles. With reference to FIG. 4F, concentrated microdot pattern 220^{#} enables the processor to register the printing plates of the press machine with a higher accuracy, than scattered microdot pattern 220* and with higher accuracy than initial microdot pattern 220. It is noted that both scattered microdot pattern 220* and concentrated microdot pattern 220^{#} are asymmetric patterns, in which the distance between each pair of microdot marks is unique. This asymmetry is particularly important in embodiments for adjusting the pressure of the plate rollers. When a portion of the microdot marks are not printed due to reduced roller plate pressure, the printed microdot marks can be uniquely identified according to the distance there-between.

With reference to FIGS. 4G and 4H, concentrated microdot pattern 220^{#} is periodically imaged by a camera. For example, camera 104 (FIG. 1) images concentrated microdot pattern 220^{#} with every rotation of the plate rollers of the press machine (e.g., plate roller 184 of FIG. 3 and press machine 100 of FIG. 1). An operator or a controller (both not shown) of the press machine can determine when a control signal is performed by the actuation interface by starting the control signal with an instruction to move one of microdot marks 224^{#}, 226^{#}, 228^{#}, 230^{#}, 232^{#} and 234^{#} of concentrated microdot pattern 220^{#}. In the example set forth in FIGS. 4G and 4H, microdot mark 228^{#} is moved back and forth. Accordingly, the operator can tell that the scattered microdot pattern was transformed into the concentrated microdot pattern. Thereby, the operator can begin measuring the distances between microdot marks, or the relative distance of each microdot mark from the reference point (i.e., on the acquired image). Since the zoom of the camera and the distance of the camera from the print material is known, the distance between the microdots on the image can be transformed to the actual distances on the print material.

For example, in case the operator or the controller executes set up operation for setting up the press machine (e.g., adjusting the pressure control or the color control of the press machine), the operator produces a series of actuation signals for the actuators of each of the plate rollers to periodically increase the contact pressure with the impression cylinder. The operator can not be sure when exactly the registration and set up system will begin moving the plate rollers of the press machine. By inserting in the beginning of the control signal, a signal to move microdot mark 228^{#} back and forth, the operator knows when the control signal takes place and can monitor the results of the set up control signal.

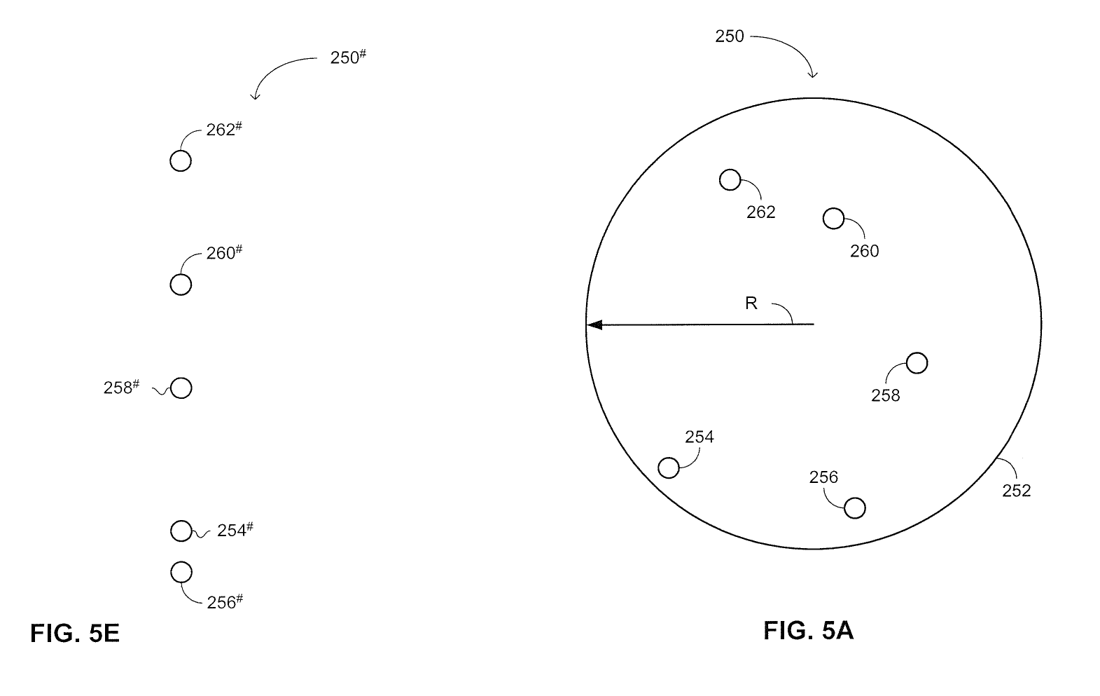

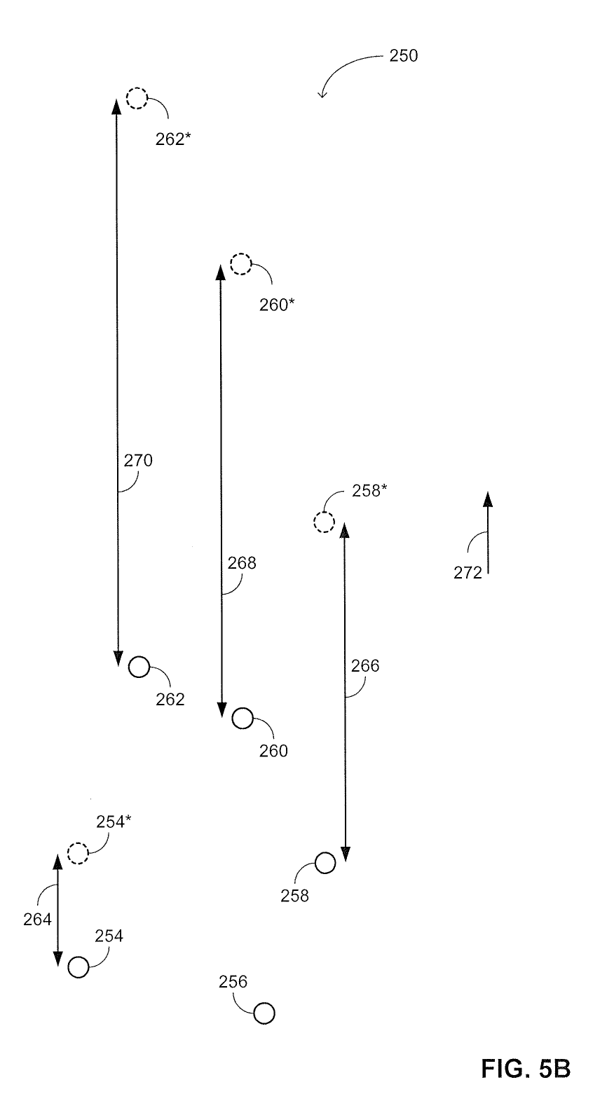

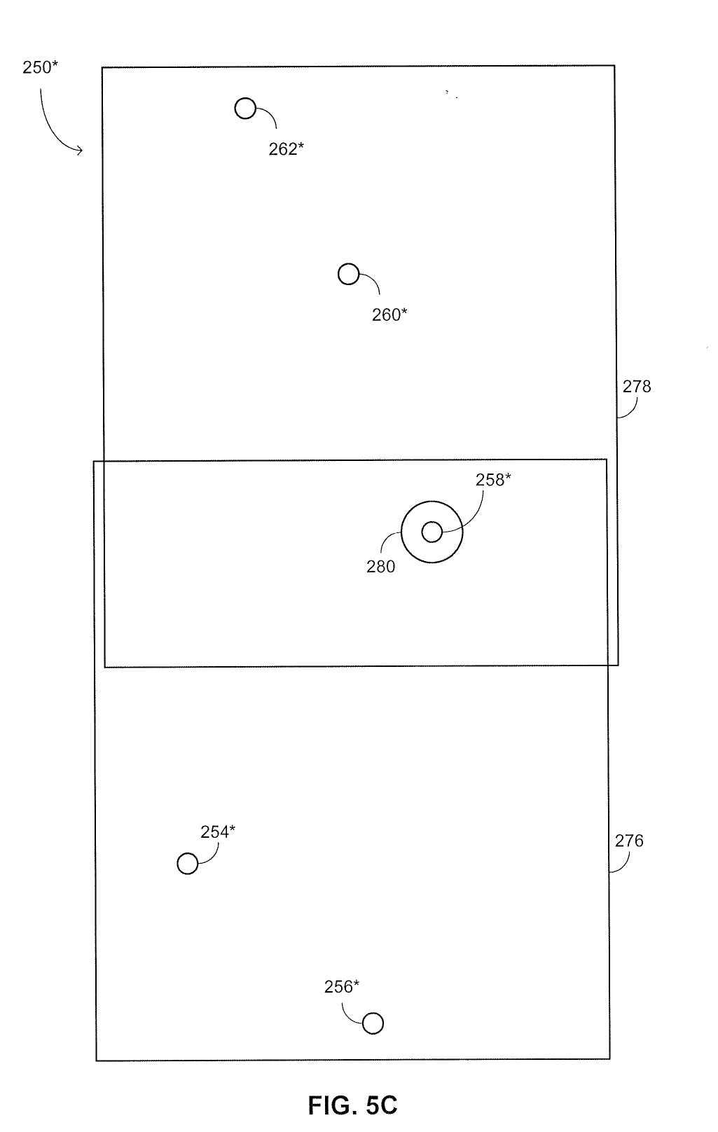

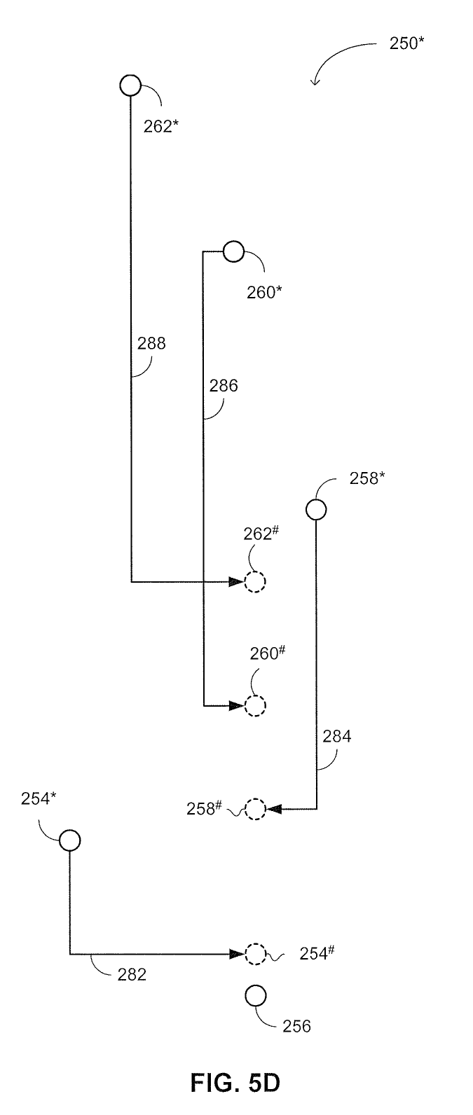

Reference is now made to FIGS. 5A, 5B, 5C, 5D and 5E, which are schematic illustrations of a single file pattern of microdot marks (i.e., single file microdot pattern), generally referenced 250, constructed and operative in accordance with a further embodiment of the disclosed technique. With reference to FIG. 5A, microdot pattern 250 includes a first microdot mark 254, a second microdot mark 256, a third microdot mark 258, a fourth microdot mark 260 and a fifth microdot mark 262. Each of microdot marks 254, 256, 258, 260 and 262 is produced by a microdot engraving of a printing plate (e.g., printing plate 184 FIG. 3) of a press machine (e.g., press machine 100 of FIG. 1).

Microdot pattern 250 is bounded by an imaginary circle 252. Imaginary circle 252 has a radius R which corresponds to the IMR of the press machine. The position of each microdot mark within microdot pattern 250 corresponds to the position of the respective printing plate of the respective plate roller. It is noted that, it might be impossible to uniquely associate each of microdot marks 254, 256, 258, 260 and 262 with each plate roller by viewing initial microdot pattern 250.

With reference to FIG. 5B, a processor (e.g., processor 102 of FIG. 1) produces a scattering control signal for an actuation interface (e.g., actuation interface 106 of FIG. 1). The scattering control signal is directed at displacing the plate rollers for scattering microdot marks 254, 256, 258, 260 and 262. The scattering of the microdots marks results in a scattered microdot pattern 250* (FIG. 5C). In the example set forth in FIG. 5B, microdot marks 254, 256, 258, 260 and 262 are scattered in a single axis.

FIG. 5B shows microdot marks 254, 256, 258, 260 and 262, before the scattering displacement, depicted as full line circles, and microdot scattered marks 254*, 256*, 258*, 260* and 262*, after the scattering displacement as dotted line circles. In particular, microdot 256 is not moved. Microdot mark 254 is moved in the direction of arrow 272 by a distance represented by arrow 264. Microdot 258 is moved in the direction of arrow 272 by a distance represented by arrow 266. Microdot mark 260 is moved in the direction of arrow 272 by a distance represented by arrow 268. Microdot mark 262 is moved in the direction of arrow 272 by a distance represented by arrow 270. It is noted that arrow 272 is substantially parallel to direction of advancement of the print substrate (e.g., print substrate 110 of FIG. 1) along the press machine.

The processor uniquely associates each of scattered microdot marks 254*, 256*, 258*, 260* and 262* with its respective plate roller according to scattered microdot pattern 250* and the scattering control signal. The magnitudes of arrows 264, 266, 268 and 270 are, for example, 2R, 4R, 6R and 8R, respectively, and the scale of arrows depicted in FIG. 5B is much shorter for fitting the Figure within a single page.

Alternatively, a first roller plate is scattered in the direction of arrow 272 by a magnitude of 2R. A second roller plate is scattered in the direction opposite of arrow 272 by a magnitude of 2R. A third roller plate is scattered in the direction of arrow 272 by a magnitude of 4R. A fourth roller plate is scattered in the direction opposite of arrow 272 by a magnitude of 4R, and so forth until only a single roller plate is not displaced. It is noted that scattering the microdot pattern is only the vertical direction wastes less of the print material as the clean area is narrower.

With reference to FIG. 5C, microdot scattered pattern 250* is imaged by a camera (e.g., camera 104 of FIG. 1). It is noted that as the scattering control signal which produced scattered microdot pattern 250* included displacement instructions in only a single axis, scattered microdot pattern 250* is elongated and might not fit into a single frame of the camera. In particular in case the camera zooms in for visibly imaging the microdot marks, scattered microdot pattern 250* might not fit within one frame. In case the camera zooms out, the size scattered microdot marks 254*, 256*, 258*, 260* and 262* in the acquired image become too small and do not have enough pixels to enable image processing, such as determining the center of each of them and measuring the distances between them.

The camera images scattered pattern 250* in two overlapping frames 276 and 278 (i.e., overlapping pair of frames or images). Frame 276 includes scattered microdot marks 254*, 256* and 258*. Frame 278 includes scattered microdot marks 258*, 260* and 262*. In the example set forth in FIG. 5C, scattered microdot mark 258* appears in both overlapping frames 276 and 278. Alternatively, at least one scattered microdot mark of scattered microdot marks 254*, 256*, 258*, 260* and 262* appears in both overlapping frames 276 and 278.

With reference to FIG. 5D, the processor produces a concentrating control signal for the actuation interface for concentrating scattered microdot marks 254*, 256*, 258*, 260* and 262* into a concentrated microdot pattern 250^{#} (FIG. 5E). In particular, scattered microdot mark 254* is displaced in accordance with arrow 282. Scattered microdot mark 258* is displaced in accordance with arrow 284. Scattered microdot mark 260* is displaced in accordance with arrow 286. Scattered microdot mark 262* is displaced in accordance with arrow 288. With reference to FIG. 5E, the processor employs concentrated microdot pattern 250^{#} for registering the plate rollers of the press machine. It is noted that, concentrated microdot pattern 250^{#} is an asymmetric pattern (i.e., the distance between each pair of marks is different).

It is noted that, in the example set forth in FIGS. 5A-5E, all the microdot marks are scattered only in a single axis. Thereby, scattered microdot pattern 250* is a single file scattered microdot pattern. A double file scattered microdot pattern (FIGS. 4A-4H) is shorter and wider than a single file scattered microdot pattern (FIGS. 5A-5E). Thus, the double file scattered microdot pattern occupies less space and fits easier within the frame of a camera. On the other hand, the clean area surrounding the wider double file scattered microdot pattern is bigger than the clean area surrounding the narrower single file scattered microdot pattern, such that a double file scattered microdot pattern wastes more of the print material than single file scattered microdot pattern. Alternatively, other scattering schemes (i.e. other than double file or single file are possible). The scattered microdot pattern should enable unique association of each microdot mark with its respective plate roller, should fit within the frame of the camera and should waste as little print material as possible.

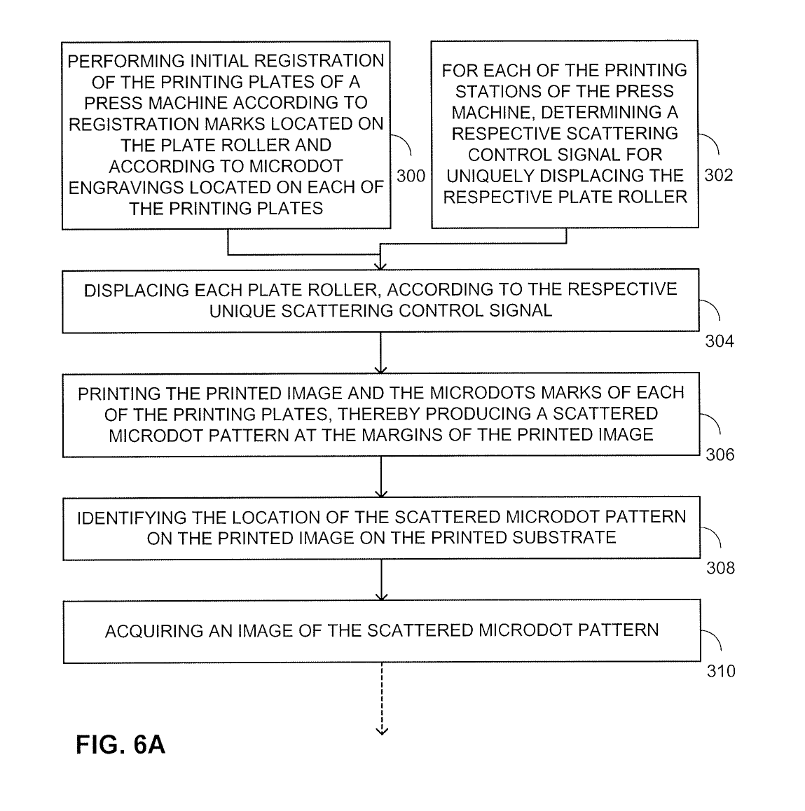

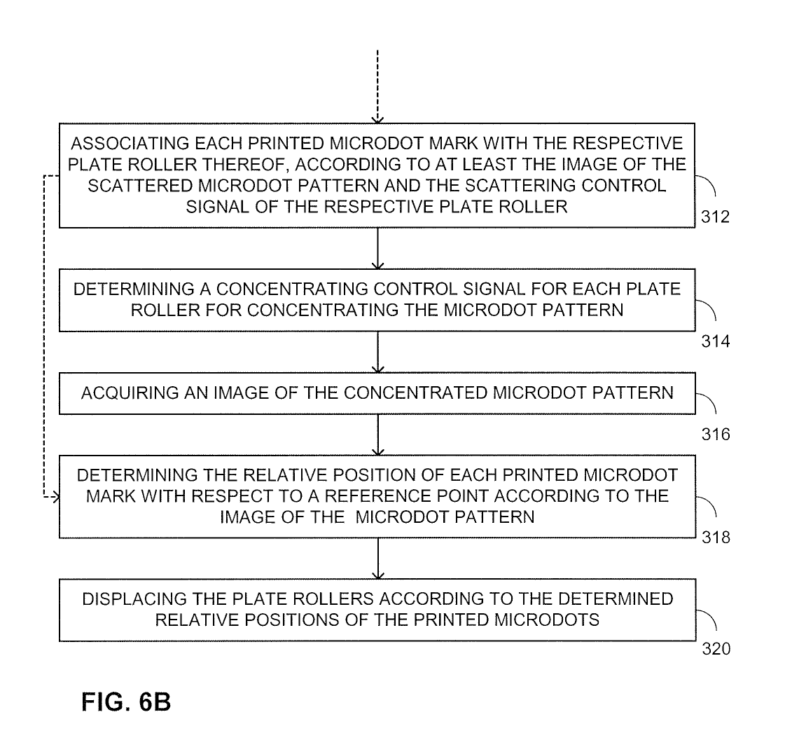

Reference is now made to FIGS. 6A and 6B, which are schematic illustrations of a method for registering and setting up a press machine, operative in accordance with another embodiment of the disclosed technique. In procedure 300, initial registration of the printing plates of a press machine is performed according to registration marks located on the plate roller (e.g., mounting pins employed for mounting the roller plate onto the press in a repeatable manner) and according to microdot engravings located on each of the printing plates. With reference to FIGS. 1 and 3, printing stations 108₁, 108₂, 108₃, . . . , 108_{N} of press machine 100 are subjected to initial registration. Each printing plate 184 includes microdot engravings 188. Each plate roller 182 includes registration marks 186. Printing stations 108₁, 108₂, 108₃, . . . , 108_{N} are registered according to the relative position of the microdot engravings 188 with respect to registration marks 186. Alternatively, printing stations 108₁, 108₂, 108₃, . . . , 108_{N}, are registered according to the relative position of the microdot marks, printed on print substrate 152 by the microdot engravings 188, with respect to registration marks 186. The accuracy of the initial registration is defined by the IMR of press machine 100.

In procedure 302, a respective scattering control signal is determined for each of the printing stations (i.e., the plate rollers of the printing stations) of the press machine, for uniquely displacing the respective plate roller. The scattering control signal is directed at scattering the microdot marks in such a manner that will enable unique association of each microdot mark with its respective plate roller according to at least the image of the scattered microdot pattern and the scattering control signal. The scattering control signal is directed at uniquely displacing each plate roller. The scattering control signal is determined while the press machine is off or at least while the printing plates are not in contact with the print substrate, so as not to waste the print substrate. With reference to FIGS. 1, processor 102 determines a scattering control signal.

In procedure 304, each printing roller is displaced according to the respective unique scattering control signal. With reference to FIGS. 1 and 2, processor 102 sends the scattering control signal to actuation interface 106. Actuation interface displaces the plate rollers of printing stations 108₁, 108₂, 108₃, . . . , 108_{N} according to the respective unique scattering control signal.

In procedure 306, the printed image and the microdots marks of each of the printing plates are printed, thereby producing a scattered microdot pattern on the margins of the printed image. After the actuators displace the roller plates of the printing stations according to the respective unique scattering control signal, the press machine is turned on and the printing plates print the engraved image thereof on the print substrate. The printing plates further print microdot marks corresponding to the microdot engravings on the print substrate. The microdot marks constitute a microdot pattern. The microdot pattern is a scattered microdot pattern as the roller plates were already displaced according to the scattering control signal. With reference to FIGS. 1 and 4C, press machine 100 is turned on and printing stations 108₁, 108₂, 108₃, . . . , 108_{N} print their respective image on print substrate 110, including the microdot marks respective of the microdot engravings of the printing plates. Thus, scattered microdot pattern 220* is printed on print substrate 110.

In procedure 308, the location of the scattered microdot pattern is identified on the printed substrate. The location of the scattered microdot pattern is identified by an operator or automatically. An operator identifies the location on the print substrate of the scattered microdot pattern by reviewing the print substrate itself or an image of the print substrate. The image of the print substrate is acquired by a camera having a wide field of view (i.e., and as a result a wide field of regard on the print substrate). The operator can have predetermined knowledge about the approximate location of the scattered microdot pattern (e.g., the scattered microdot pattern is located on the margins of the printed image on the print substrate). The operator can mark the scattered microdot pattern by employing a scattered pattern cursor, which corresponds to the scattering signal. With reference to FIGS. 1, 3, 4C and 4D, camera 104 scans print substrate 110, and acquires images thereof. An operator (not shown) reviews the acquired scanning images of print substrate 110 and looks for scattered microdot pattern 220* thereon (the operator is looking for pattern 220* on the margins of the printed image of print substrate 110). The operator identifies the location of scattered microdot pattern 220* on print substrate 110 and aims camera 104 thereon. The operator can mark scattered microdot pattern 220* by maneuvering scattered pattern cursor 240 onto scattered microdot pattern 220*.

In procedure 310, an image of the scattered microdot pattern is acquired. The image of the scattered microdot pattern is acquired by a camera at a zoom level higher than the zoom level employed for scanning the print substrate while looking for the scattered microdot pattern. As detailed herein above, the size of each microdot mark is approximately 0.2 millimeters. The zoom level of the camera when acquiring the image of the scattered microdot pattern should be such that each microdot mark occupies at least three pixels of the camera for clearly viewing each microdot mark. Accordingly, the FOV of the camera will be smaller than the FOV of the camera when scanning the print substrate for identifying the scattered microdot pattern. With reference to FIGS. 1 and 4C, camera 104 acquires an image of scattered microdot pattern 220* on print substrate 110.

In procedure 312, each printed microdot mark is associated with its respective plate roller, according to at least the image of the scattered microdot pattern and the scattering control signal of the respective plate roller. There are a variety of methods for associating each microdot mark of the scattered microdot pattern with its respective plate roller according to the image of the scattered microdot pattern and the scattering control signal.

An example of a first method involves comparing the image of the scattered microdot pattern to an image of the initial microdot pattern. Each scattered microdot mark is subjected to a reverse displacement respective of each of the unique control signals for each of the plate rollers. In case the scattered microdot mark after being subjected to a reverse displacement respective of the control signal of a first plate roller, coincides with a microdot mark of the initial microdot pattern, the microdot mark is associated with the first plate roller.

Another example of a method for associating the scattered microdot marks with the respective plate rollers involves analyzing image of the scattered microdot pattern in view of the scattering control signal. In case the first roller plate was displaced by the largest distance to a first direction, the microdot mark located at the edge of the scattered microdot pattern, which corresponds to the first direction, is associated with the first plate roller. The second method requires that the microdot marks are scattered such that each mark was displaced by a distance exceeding twice the IMR of the press machine from the other marks.

With reference to FIGS. 1 and 4C, processor 102 uniquely associates each of scattered microdot marks 224*, 226*, 228*, 230*, 232* and 234* of scattered microdot pattern 220*, with its respective one of the plate rollers of press machine 100 according to an image of scattered microdot pattern 220* and the scattering control signal. In particular, in the example set forth in FIG. 4C, the left uppermost scattered microdot mark 226* corresponds to the roller plate which received the unique scattering control signal of moving in the direction opposite of arrow 236 by a distance of R and further moving in the direction of arrow 238 by a distance of 4R. The right uppermost scattered microdot mark 228* corresponds to the roller plate which received the unique scattering control signal of moving in the direction of arrow 236 by a distance of R and further moving in the direction of arrow 238 by a distance of 4R. The left middle scattered microdot mark 230* corresponds to the roller plate which received the unique scattering control signal of moving in the direction opposite of arrow 236 by a distance of R and further moving in the direction of arrow 238 by a distance of 2R. The right middle scattered microdot mark 234* corresponds to the roller plate which received the unique scattering control signal of moving in the direction of arrow 236 by a distance of R and further moving in the direction of arrow 238 by a distance of 2R. The left bottom scattered microdot mark 232* corresponds to the roller plate which received the unique scattering control signal of moving in the direction opposite of arrow 236 by a distance of R. The right bottom scattered microdot mark 224* corresponds to the roller plate which received the unique scattering control signal of moving in the direction of arrow 236 by a distance of R.

It is noted that it is possible to skip procedures 314 and 316 and move from procedure 312 straight to procedure 318. Procedures 314 and 316 are directed at improving the accuracy of the registration of the printing plates. In case the accuracy of the registration employing the scattered microdot pattern is sufficient, procedures 314 and 316 are redundant.

In procedure 314, a concentrating control signal is determined for each plate roller for concentrating the microdot pattern. The concentrating control signal is directed at displacing the plate rollers for concentrating the microdot pattern printed thereby. The concentrating control signal is determined according to the scattered microdot pattern. The concentrating control signal can further be determined according to the desired accuracy of the registration process, the camera (e.g., the zoom and the FOV of the camera), and the like. The concentrated microdot pattern enables a more accurate registration of the printing plates. In particular, the concentrated microdot pattern enables a more accurate measurement of the distances between the microdot marks of the microdot pattern, and a more accurate measurement of the relative position of each microdot mark with respect to a reference point.

In the concentrated microdot pattern the distances between pairs of microdot marks are smaller than the respective distances in the scattered microdot pattern or in the initial microdot pattern (i.e., produced by the initial registration). The error of distance measurement depends on the measured distance. For example, the error is 1% of the measured distance. In this case, an error of a distance of 10 centimeters is 1 millimeter, and an error of a distance of 1.5 centimeters is 0.15 millimeter.

Additionally, the camera can acquire an image of the concentrated microdot pattern with a small FOV and a high zoom level. In this manner, the measurements of distances are more accurate as the FOV is smaller and each microdot mark of the concentrated microdot pattern occupies more pixels of the image.

Additionally, in case the print substrate is flexible, the position of the microdot pattern might shift with the rotations of the plate rollers (i.e., the image of the microdot pattern is periodically acquired at a slightly different location due to the flexibility of the print substrate). By concentrating the microdot pattern and centering the microdot pattern within the frame of the camera, the chances of missing a portion of the concentrated microdot pattern are decreased. Put another way, the concentrated microdot pattern is easier to catch within the frame of the camera.

It is noted that the concentrated microdot pattern is asymmetric, (i.e., that the relative distance between each pair of microdot marks is different). In this manner even if only two microdot marks are printed the microdot marks can be uniquely identified according to the distance therebetween.

With reference to FIGS. 1, 4C and 4F, processor 102 determines a concentrating control signal for actuation interface 106 for displacing the plate rollers of press machine 100. The concentrating control signal is directed at producing a concentrated microdot pattern 220^{#} which enables higher accuracy of the registration of the printing plates. Processor 102 determines the concentrated control signal according to scattered microdot pattern 220*. Processor 102 can further determine the concentrating control signal according to the desired accuracy of the registration process, the FOV and the zoom levels of camera 104, and the like.

In procedure 316, an image of the concentrated microdot pattern is acquired. The image of the concentrated microdot pattern is acquired at a FOV which is smaller than the FOV required for imaging the scattered microdot pattern (i.e., higher zoom level). With reference to FIGS. 1 and 4F, camera 104 acquires an image of concentrated microdot pattern 220^{#}.

In procedure 318, the relative position of each printed microdot mark with respect to a reference point is determined, according to the image of the microdot pattern. The relative position of each microdot mark with respect to a reference point enables registration of the printing plates corresponding to the microdot marks with each other. With reference to FIGS. 1 and 4F, camera 104 provides an image of the concentrated microdot pattern 220^{#} to processor 102. Processor 102 determines the relative position of each of microdot marks 224^{#}, 226^{#}, 228^{#}, 230^{#}, 232^{#} and 234^{#} with respect to a reference point (not shown). Alternatively, processor 102 determines the distances between each pair of microdot marks 224^{#}, 226^{#}, 228^{#}, 230^{#}, 232^{#} and 234^{#}. Processor 102 registers the printing plates of press machine 100 according to the determined relative positions or according to the distances between each pair, of microdot marks 224^{#}, 226^{#}, 228^{#}, 230^{#}, 232^{#} and 234^{#}. Processor 102 determines a registration control signal for actuation interface 106 for displacing the plate rollers to a registered configuration of press machine 100, in which the printed image of each printing plate is aligned with the printed images of the other printing plates on the print substrate. In other words, the registration control signal is directed at overlapping the microdot marks of all the plate rollers of the press machine thereby registering the plate rollers of the press machine.

In procedure 320, the plate rollers are displaced according to the determined relative positions of the printed microdots. The plate rollers are displaced into a registered configuration, in which the respective printed images of the printing plates of the press machine are aligned on the print substrate. With reference to FIG. 1, processor 102 determines a registration control signal. Actuation interface 106 displaces the plate rollers of press machine 100 according to the registration control signal. The plate rollers of press machine 100 are registered with each other. The microdot marks respective of the plate rollers are overlapping.

In the examples detailed herein above with reference to FIGS. 1, 2, 3A-3D, 4A-4H, 5A-5E and 6A-6B, the disclosed technique was employed for registering the plate rollers of a press machine. The disclosed technique provides a phased process which can further be employed for any set-up, control or adjustment of parameters in a printing press. For example, setting up the pressure of the roller plates of the press machine or setting up the color of the press machine as detailed herein below. The phased approach provides a gradual increase of zoom level while controlling the scattering of the fiducials (e.g., microdot marks) in a manner that enables automatically identifying which fiducial relates to which printing unit. For each level of zoom there exists a pattern that enables practical identification and image analysis. The higher the zoom level, the more accurate the image processing results will be.

The system and method of the disclosed technique are employed for setting up the pressure between the plate roller and the impression cylinder and between the plate roller and the anilox roller of each of the printing stations of a press machine.

With reference to FIGS. 1 and 2, processor 102 provides a separation control signal to actuators 148 for moving anilox rollers 142 and plate rollers 144 away from print substrate 152 and away from each other. When no ink is transferred from anilox roller 142 to plate roller 144 and from plate roller 144 to print substrate 152, the distance between anilox roller 142 and plate roller 144 is defined as dₙₒ₋ₚᵣᵢₙₜ. Processor 102 associates the distance dₙₒ₋ₚᵣᵢₙₜ between anilox roller 142 and plate roller 144, with a no-print threshold T₁ respective of the pair of first roller 110 and second roller 114.

It is noted that processor 102 can search for the no-print threshold T₁ in a recursive manner, by directing actuators 148 to move anilox roller 142 and plate roller 144 back and forth away and towards one another to distances greater than, less than, or equal to dₙₒ₋ₚᵣᵢₙₜ, respectively, until processor 102 determines that the microdot marks respective of plate roller 144 are absent from printed substrate 152. It is further noted that processor 102 can determine no-print threshold T₁ by directing actuators 108 to initially set the distance between anilox roller 142 and plate roller 144, at a distance greater than dₙₒ₋ₚᵣᵢₙₜ, for example at dₘₐₓ, where the microdot marks respective of plate roller 144 are not printed. Alternatively, processor 102 can determine no-print threshold T₁ by directing actuators 108 to initially set the distance between the microdot marks respective of plate roller 144, at any distance less than dₙₒ₋ₚᵣᵢₙₜ.

Processor 102 can search for the no-print threshold, dₙₒ₋ₚᵣᵢₙₜ, according to methods known in the art. Searching for dₙₒ₋ₚᵣᵢₙₜ is similar to searching a value in a sorted list. Such methods are, for example, a binary search, linear search, and the like. In these types of searches, the distance between the rollers is equivalent to the index (i.e., the numbered place of a value) of the values in the list. The binary search begins by dividing the sorted list into two parts, at the median index. When processor 102 detects a microdot mark, respective of a printing station, printed on print substrate 152, then, processor 102 disregards the part of the list with indices (i.e., distances) smaller than the median distance. When processor 102 does not detect a microdot mark, respective of a printing station, printed on the print material, then, processor 102 disregards the part of the list with indices (i.e., distance) larger than the median distance. Processor 102 repeats the above process with the half list that was not disregarded, and treats this half list as a new sorted list.

Processor 102 directs actuators 108 to move anilox roller 142 back toward plate roller 144 to ensure that the microdot marks are printed on print substrate 152. At this point, the distance between plate roller 144 and impression cylinder 146 is minimal, plate roller 144 and impression cylinder 146 transfer the ink from the ink tank to substrate 152, and camera 104 detects the presence of microdot marks which plate roller 144 prints. Processor 102 determines a no-print threshold T₂ respective of the pair of plate roller 144 and impression cylinder 146, similar to the way processor determines the no-print threshold T₁ respective of the pair of anilox roller 142 and plate roller 144, as described herein above.

In order to setup printing station 140, an operator (not shown) enters one or more printing parameters to processor 102, via a user interface (not shown), coupled with processor 102. Processor 102 directs actuators 108 to move anilox roller 142 and plate roller 144, respectively (i.e., set the distances between anilox roller 142 and plate roller 144), according to the printing parameters, relative to the no-print thresholds T₁ and T₂, respectively. Processor 102 directs actuators 108 to set the distances between anilox roller 142 and plate roller 144, at a working distance d_{work} (i.e., the distance between anilox roller 142 and plate roller 144 at which printing station 140 prints the respective printing job thereof), determined from the entered printing parameters. The printing parameters can be the material of the outer surface of each of anilox roller 142, plate roller 144, and of impression cylinder 146, the thickness of the material of the outer surface of second roller 114, the roughness and hardness of the material of the outer surface of anilox roller 142, physical properties of the ink in an ink tank 150 (e.g., viscosity, temperature, color), the type of print substrate 152 (e.g., paper weight), speed of travel of print substrate 152, and the like.

Processor 102 can direct actuators 108 to set the distances between anilox roller 142 and plate roller 144, according to the printing parameters, for example, by employing a look-up table, an algorithm, and the like. Printing station 140 is a flexographic printing station. However, it is noted that the disclosed technique applies to other types of printing presses, such as gravure, offset, and the like.

The system and method of the disclosed technique are employed for setting up the color (i.e., the ink parameters such as density, temperature, layer thickness, and the like) of each of the printing stations of a press machine. With reference to FIGS. 1 and 2, printing stations 108₁, 108₂, 108₃, . . . , 108_{N}, produce a microdot pattern on print substrate 152. Each microdot mark of the microdot pattern is associated with its respective printing station according to the disclosed technique (procedures 300-312 of FIGS. 6A and 6B). The microdot pattern is employed as a test image area for setting up the colors of press machine 100.

A spectrophotometer (not shown) images the microdot pattern and produces spectral reflectance data respective of a plurality of predetermined wavelengths. Processor 102 compares the spectral reflectance data with target reflectance data, represented in the same color space, such that color differences can be calculated. The target reflectance data is stored on a database (not shown) coupled with processor 102. Processor 102 compares the color differences with predetermined color tolerances stored on the database. In case the color differences exceed the color tolerances, a color correction is required. Processor 102 calculates color correction signal according to the determined color differences. The color correction signal can relate to any of color density, color temperature, layer thickness, and the like.

It will be appreciated by persons skilled in the art that the disclosed technique is not limited to what has been particularly shown and described hereinabove. Rather the scope of the disclosed technique is defined only by the claims, which follow.

1. A method for registering a press machine including a plurality of printing stations, each including a plate roller mounted with a printing plate, each printing plate including a microdot engraving, the method comprising the procedures of:
displacing at least a portion of the plate rollers, each in a unique scattered displacement, with respect to each of the other plate rollers;
printing on a print substrate a respective microdot mark by each one of said plate rollers thereby producing a scattered microdot pattern;
acquiring an image of said scattered microdot pattern;
associating each one of said plate rollers with said respective microdot mark according to the position of said respective microdot mark relative to the other microdot marks in said scattered microdot pattern, and according to the unique scattered displacement of said one of said plate rollers; and
displacing at least a portion of said plate rollers to a registered position, each according to the position of said respective microdot mark relative to said other microdot marks.

2. The method according to claim 1, further comprising a procedure of determining for each one of said portion of said plate rollers a respective scattering control signal associated therewith, corresponding to said unique scattered displacement of said one of said plate rollers,
wherein said procedure of displacing at least a portion of the plate rollers, each in a unique scattered displacement, is performed according to the respective scattering control signal associated with each one of said portion of said plate rollers.

3. The method according to claim 1, wherein said procedure of acquiring an image including the sub-procedure of identifying the location of said scattered microdot pattern on said print substrate.

4. The method according to claim 3, wherein said procedure of identifying being performed by an operator.

5. The method according to claim 3, wherein said procedure of identifying being performed by a wide field of view camera.

6. The method according to claim 1, wherein said method further comprising a preliminary procedure of initially registering said plate rollers according to registration marks located on said plate rollers and according to each said microdot engraving, the accuracy of said initial registration being defined by the initial mis-registration of said press machine.

7. The method according to claim 6, wherein said procedure of associating including the sub-procedures of:
prior to said procedure of displacing at least a portion of the plate rollers, each in a unique scattered displacement, printing on a print substrate a respective microdot mark by each one of said plate rollers thereby producing an initial microdot pattern;
acquiring an image of said initial microdot pattern; and
after said procedure of acquiring an image of said scattered microdot pattern, mapping each said respective microdot mark of said scattered microdot pattern to a respective microdot mark of said initial microdot pattern according to said unique scattered displacement of said respective one of said plate rollers.

8. The method according to claim 1, wherein said procedure of associating including the sub-procedures of:
measuring said position of said respective microdot mark relative to the other microdot marks according to said acquired image of said scattered microdot pattern;
identifying for each said microdot mark said unique scattered displacement of said one of said plate rollers corresponding to said position of said respective microdot mark; and
associating each said one of said plate rollers with said respective microdot mark according to said identified unique scattered displacement.

9. The method according to claim 1, wherein each said unique scattered displacement differs from the other unique scattered displacements by at least twice the initial mis-registration of said press machine.

10. The method according to claim 1, wherein said scattered microdot pattern is an asymmetric pattern, in which the distance between each pair of said microdot marks is different.

11. The method according to claim 1, further including a procedure of producing a concentrated microdot pattern after said procedure of associating, said procedure of producing a concentrated microdot pattern including the sub-procedures of:
displacing at least a portion of said plate rollers, each in a unique concentrated displacement, with respect to each of the other plate rollers;
printing on said print substrate a respective microdot mark by each one of said plate rollers thereby producing a concentrated microdot pattern; and
acquiring an image of said concentrated microdot pattern.

12. The method according to claim 11, wherein said procedure of displacing at least a portion said plate rollers to a registered position being performed according to the position of said respective microdot mark relative to the other microdot marks in said concentrated microdot pattern.

13. The method according to claim 12, wherein said concentrated microdot pattern is an asymmetric pattern, in which the distance between each pair of said microdot marks is different.

14. The method according claim 1, further comprising a procedure of indicating to an operator of said press machine that the actuation of said press machine according to an actuation signal has begun, said actuation signal beginning with a displacement of a selected one of said plate rollers such that said respective microdot mark thereof, being displaced in a predetermined manner.

15. The method according to claim 1, wherein said procedure of acquiring an image of said scattered microdot pattern including acquiring a plurality of successive overlapping images of said scattered microdot pattern, at least one of said microdot marks appearing in each overlapping pair of said overlapping images.

16. The method according to claim 1, further comprising a procedure of setting up the color of each of said printing stations, wherein said microdot pattern is employed as a test image area for setting up the color of said press machine.

17. The method of claim 16, wherein said procedure of setting up the color including the sub-procedures of:
producing spectral reflectance data respective of a plurality of predetermined wavelengths for said microdot pattern;
comparing said spectral reflectance data with target reflectance data and determining color differences;
comparing said determined color differences with predetermined color tolerances; and
calculating a color correction signal according to said determined color differences.

18. The method of claim 17, wherein said color correction signal relates to one of:
color density;
color temperature; and
layer thickness.

19. The method of claim 1, further comprising the procedure of measuring the position of each said microdot mark relative to a reference point according to the position of said microdot marks in said acquired image of said scattered microdot pattern, prior to said procedure of displacing each one of said plate rollers to a registered position.

20. The method of claim 11, further comprising the procedure of measuring the position of each said microdot mark relative to a reference point according to the position of said microdot marks in said acquired image of said concentrated microdot pattern, prior to said procedure of displacing each one of said plate rollers to a registered position.
